(19) United States
(12) Patent Application Publication
(10) Pub. No.: US 2007/0033406 A1
(43) Pub. Date: Feb. 8, 2007

(54) Information processing apparatus and method, and program

(75) Inventors: Naofumi Hanaki, Kanagawa (JP); Hideki Akashika, Tokyo (JP); Jun Ogishima, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: FeliCa Networks, Inc., Shinagawa-ku (JP)

(21) Appl. No.: 11/496,459

(22) Filed: Aug. 1, 2006

(30) Foreign Application Priority Data
Aug. 2, 2005 (JP) 2005-223738

(51) Int. Cl. H04L 9/00

(52) U.S. Cl. 713/171

(57) ABSTRACT

An information processing apparatus for performing processing of a storage device which includes first storage means for storing encryption key setting information and package setting information, second storage means for storing an encryption key linked to the encryption key setting information, third storage means for storing a package linked to the package setting information. The information processing apparatus includes deleting means for, when the encryption key linked to the encryption key setting information has been deleted in the second storage means, deleting from the third storage means the package corresponding to the deleted encryption key, and generating means for, when the package corresponding to the deleted encryption key has been deleted from the third storage means and a new encryption key has been stored in the second storage means, generating a new package corresponding to the new encryption key and storing the new package in the third storage means so as to be linked with the package setting information.

### CROSS REFERENCES TO RELATED APPLICATIONS

The present invention contains subject matter related to Japanese Patent Application JP 2005-223738 filed in the Japanese Patent Office on Aug. 2, 2005, the entire contents of which are incorporated herein by reference.

### BACKGROUND OF THE INVENTION

1. Field of the Invention

The present invention relates to information processing apparatus and methods, recording media, and programs. In particular, the present invention relates to an information processing apparatus, a recording medium, and a program which can facilitate changing of an encryption key or a package to be provided to an IC chip.

2. Description of the Related Art

Recently, electronic payment systems have become widespread, in which electronic money is deposited in non-contact IC chips such as Felica™ embedded in credit cards or mobile phone devices and used for product purchase. Japanese Unexamined Patent Application Publication No. 2003-141063 describes a server-client system for building such an electronic money system.

Users of credit cards or mobile phone devices simply place their cards or devices over terminals (reader/writers) installed in stores to purchase products, and thus can perform payment rapidly.

When credit cards or mobile phone devices containing non-contact IC chips therein are placed over terminals, the non-contact IC chips send and receive encrypted information to and from server apparatuses which manage the non-contact IC chips (data stored in the non-contact IC chips) via terminals and networks such as the Internet.

FIG. 1 illustrates an example of encryption keys stored in a non-contact IC chip used for exchanging encrypted information.

A memory of the non-contact IC chip includes spaces of three concepts: “System”, “Area”, and “Service”, for example, and in this order each of the spaces are hierarchically formed. Specifically, a single or a plurality of “Areas” are formed in a single “System”, and a single or a plurality of “Services” are formed in each “Area”. In the example of FIG. 1, under “System”, a single “Area 1” is formed, and under “Area 1”, a single “Service 1” is formed.

An encryption key is set in each of the spaces of “System”, “Area”, and “Service”. In the example of FIG. 1, an encryption key 1, an encryption key 2, and an encryption key 3 are set in “System”, “Area 1”, and “Service 1”, respectively.

Only a server apparatus that has keys common to the non-contact IC chip (keys corresponding to those stored in the non-contact IC chip) can access each space in the non-contact IC chip (i.e., execute command to write information to each space).

FIG. 2 illustrates an example of a key storage database (DB) in a server apparatus.

The key storage DB stores the same encryption keys as those stored in the non-contact IC chip, for each non-contact IC chip to and from which the server apparatus sends and receives information, as shown in FIG. 2.

For example, for the non-contact IC chip shown in FIG. 1, the key storage DB stores an issuance package as a package type, an encryption key 1 identical to that stored in the space of “System”, an encryption key 2 identical to that stored in “Area 1”, an encryption key 3 identical to that stored in “Service 1”, and a package A as a generated package. In addition, the key storage DB, for another non-contact IC chip (not shown), stores an issuance package as a package type, the encryption key 1 identical to that stored in “System”, an encryption key 4 identical to that stored in “Area 2”, an encryption key 5 identical to that stored in “Service 2”, and an issuance package B as a generated package.

Note that a package is referred to as information concerning an encryption key (cryptographic information) appended to a command for encryption key registration when the encryption key is supplied (registered in a non-contact IC chip), so that confidentiality is ensured. Therefore, when the encryption key is changed, a different package corresponding to the encryption key is used. In addition, there are a plurality of types of package which depends on which of the encryption key in “System”, “Area”, or “Service” the package is intended to be used. For example, as shown in FIG. 2, when the package type is “issuance package”, “issuance package A” which is generated on the basis of this package type contains information concerning the encryption key 1 and the encryption key 2 corresponding to “System” and “Area 1”, respectively. Further, for example, when the package type is “service registration package”, a package generated on the basis of this package type (a service registration package) contains information concerning only the encryption key corresponding to “Service”.

Thus, in such a known key storage DB in a server apparatus, encryption keys corresponding to the spaces of “System”, “Area”, and “Service”, a generated package, and a package type indicating the type of package generated are stored as a set for each non-contact IC chip with which the server apparatus exchanges information.

### SUMMARY OF THE INVENTION

However, when the encryption key corresponding to “Service 1” in the non-contact IC chip of FIG. 1 (the encryption key 3) is changed, for example, it is not possible to delete only the encryption key 3 in the known key storage DB, since, for each non-contact IC chip of FIG. 1, the encryption keys 1, 2, and 3 corresponding to “System”, “Area 1”, and “Service 1”, the generated “issuance package A”, and the “issuance package” representing the package type of “issuance package A” are managed (stored) as a set.

Specifically, in a known technique, when any one of encryption keys corresponding to “System”, “Area”, and “Service” in a non-contact IC chip is changed in a key storage DB of a server apparatus, it is necessary to delete all information managed in the non-contact IC chip and then reregister (update) information including information which is not intended to be deleted.

The present invention has been made in view of the above circumstance and therefore serves to facilitate changing of an encryption key or a package to be provided to an IC chip.

Accordingly, an information processing apparatus according to an embodiment of the present invention performs processing of a storage device including first storage means for storing encryption key setting information representing an encryption key used for sending and receiving encrypted information to and from an IC (Integrated Circuit) chip and package setting information representing a package having information concerning the encryption key, second storage means for storing the encryption key linked to the encryption key setting information in the first storage means, and third storage means for storing the package linked to the package setting information in the first storage means, includes deleting means for, when the encryption key linked to the encryption key setting information in the first storage means has been deleted in the second storage means, deleting from the third storage means the package corresponding to the deleted encryption key linked to the package setting information in the first storage means; and generating means for, when the package corresponding to the deleted encryption key has been deleted from the third storage means and a new encryption key has been stored in the second storage means instead of the deleted encryption key, generating a new package corresponding to the new encryption key linked to the encryption key setting information in the first storage means and storing the new package in the third storage means so as to be linked with the package setting information in the first storage means.

The storage device may be included in the information processing apparatus.

The first storage means can further store information indicating whether or not the encryption key can be used.

The information processing apparatus can further be provided with changing means for changing the information indicating whether or not the encryption key can be used.

The information processing apparatus can further be provided with responding means for responding to a request for use of the encryption key received from a server for sending and receiving encrypted information to and from the IC chip, in accordance with the information indicating whether or not the encryption key can be used.

In an information processing method according to an embodiment of the present invention, information processing for processing a storage device is performed which has first storage means for storing encryption key setting information representing an encryption key used for sending and receiving encrypted information to and from an IC (Integrated Circuit) chip and package setting information representing a package having information concerning the encryption key, second storage means for storing the encryption key linked to the encryption key setting information in the first storage means, and third storage means for storing the package linked to the package setting information in the first storage means. This information processing method includes the steps of: when the encryption key linked to the encryption key setting information in the first storage means has been deleted in the second storage means, deleting from the third storage means the package corresponding to the deleted encryption key linked to the package setting information in the first storage means; and, when the package corresponding to the deleted encryption key has been deleted from the third storage means and a new encryption key has been stored in the second storage means instead of the deleted encryption key, generating a new package corresponding to the new encryption key linked to the encryption key setting information in the first storage means and storing the new package in the third storage means so as to be linked with the package setting information in the first storage means.

A program according to an embodiment of the present invention causes a computer to execute information processing for processing a storage device having first storage means for storing encryption key setting information representing an encryption key used for sending and receiving encrypted information to and from an IC (Integrated Circuit) chip and package setting information representing a package having information concerning the encryption key, second storage means for storing the encryption key linked to the encryption key setting information in the first storage means, and third storage means for storing the package linked to the package setting information in the first storage means. This program includes the steps of: when the encryption key linked to the encryption key setting information in the first storage means has been deleted in the second storage means, deleting from the third storage means the package corresponding to the deleted encryption key linked to the package setting information in the first storage means; and, when the package corresponding to the deleted encryption key has been deleted from the third storage means and a new encryption key has been stored in the second storage means instead of the deleted encryption key, generating a new package corresponding to the new encryption key linked to the encryption key setting information in the first storage means and storing the new package in the third storage means so as to be linked with the package setting information in the first storage means.

According to an aspect of the present invention, storage device is processed which has first storage means for storing encryption key setting information representing an encryption key used for sending and receiving encrypted information to and from an IC (Integrated Circuit) chip and package setting information representing a package having information concerning the encryption key, second storage means for storing the encryption key linked to the encryption key setting information in the first storage means, and third storage means for storing the package linked to the package setting information in the first storage means. When the encryption key linked to the encryption key setting information in the first storage means has been deleted in the second storage means, the package corresponding to the deleted encryption key linked to the package setting information in the first storage means is deleted from the third storage means. When the package corresponding to the deleted encryption key has been deleted from the third storage means and a new encryption key has been stored in the second storage means instead of the deleted encryption key, a new package corresponding to the new encryption key linked to the encryption key setting information in the first storage means is generated and the new package is stored in the third storage means so as to be linked with the package setting information in the first storage means.

According to an embodiment of the present invention, encryption key or a package to be provided to an IC chip can be stored in a storage device.

Further, according to an embodiment of the present invention, changing of an encryption key or a package to be provided to an IC chip can readily be performed.

### BRIEF DESCRIPTION OF THE DRAWINGS

FIG. 1 illustrates an example of encryption keys stored in a non-contact IC chip;

FIG. 2 illustrates an example of encryption keys stored in a known key storage DB;

FIG. 3 is a block diagram illustrating a configuration of a server-client system according to an embodiment of the present invention;

FIG. 4 is a block diagram illustrating a hardware configuration of a server apparatus according to an embodiment of the present invention;

FIG. 5 illustrates an example of data in a key storage DB according to an embodiment of the present invention;

FIG. 6 illustrates a state of a package;

FIG. 7 is a block diagram illustrating a functional configuration of a DB management application according to an embodiment of the present invention;

FIG. 8 illustrates package update processing;

FIG. 9 illustrates package update processing;

FIG. 10 illustrates package update processing;

FIG. 11 illustrates package update processing;

FIG. 12 illustrates package update processing;

FIG. 13 is a flowchart illustrating package update processing;

FIG. 14 is a flowchart illustrating package generation processing;

FIG. 15 illustrates another package update processing;

FIG. 16 is a flowchart illustrating another package update processing;

FIG. 17 is a flowchart illustrating further another package update processing;

FIG. 18 is a flowchart illustrating package state change processing; and

FIG. 19 is a flowchart illustrating use request response processing.

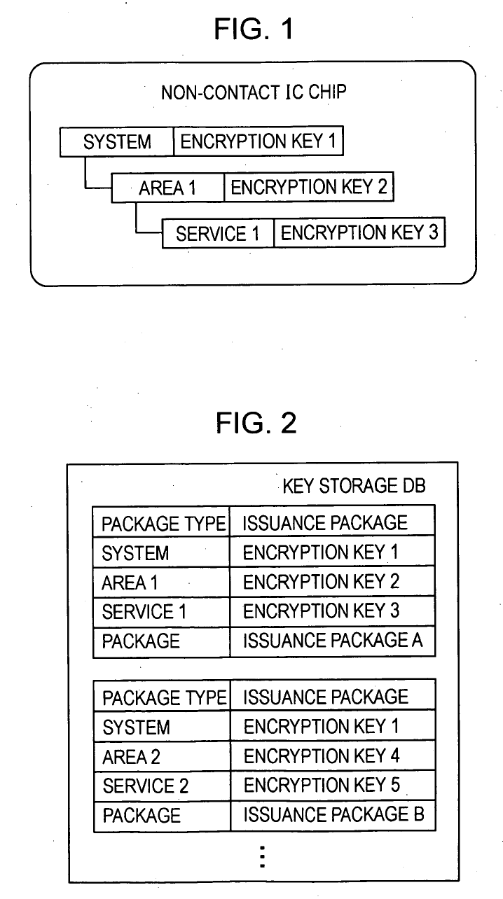

### DESCRIPTION OF THE PREFERRED EMBODIMENTS

Before describing an embodiment of the present invention, the correspondence between the features of the claims and the specific elements disclosed in an embodiment of the present invention is discussed below. This description is intended to assure that embodiments supporting the claimed invention are described in this specification. Thus, even if an embodiment in the following detailed description is not described as relating to a certain feature of the present invention, that does not necessarily mean that the embodiment does not relate to that feature of the claims. Conversely, even if an embodiment is described herein as relating to a certain feature of the claims, that does not necessarily mean that the embodiment does not relate to other features of the claims.

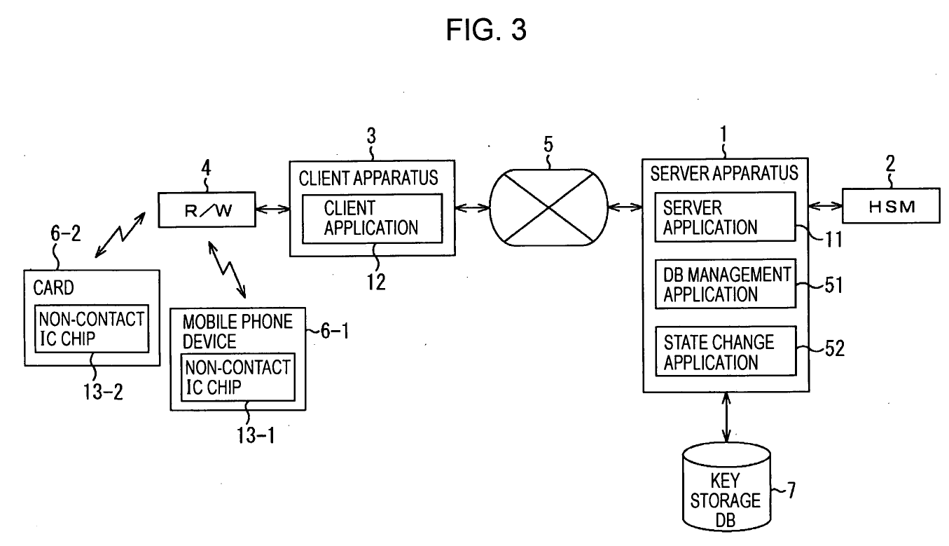

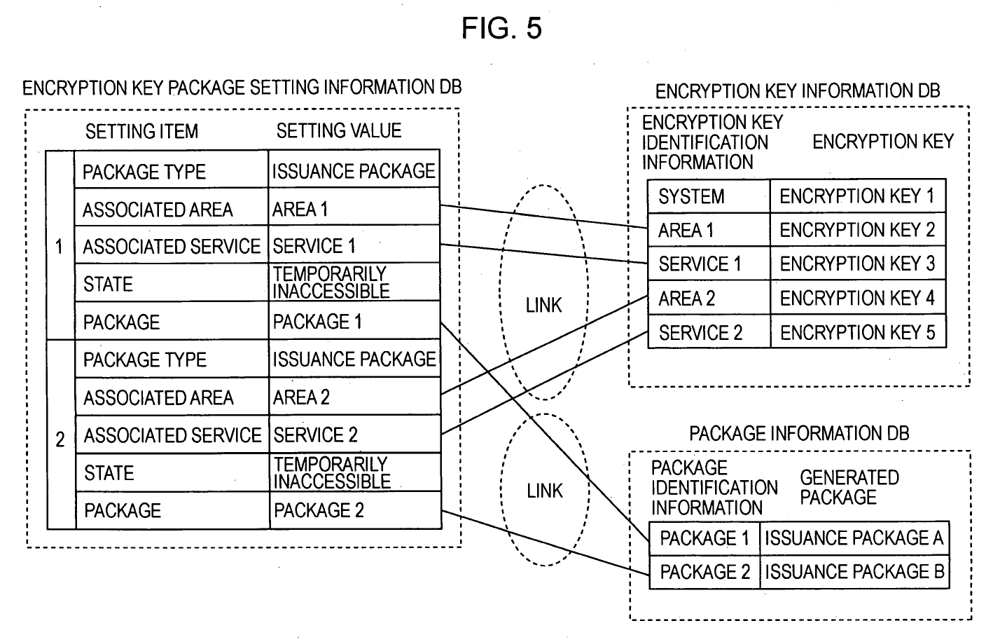

According to an embodiment of the present invention, an information processing apparatus (for example, a server apparatus 1 in FIG. 3) controls a storage device (for example, a key storage DB 7 in FIG. 3) which has first storage means (for example, an encryption key package setting information DB in FIG. 5) for storing encryption key setting information representing an encryption key used for sending and receiving encrypted information to and from an IC (Integrated Circuit) chip and package setting information representing a package having information concerning the encryption key, second storage means (for example, an encryption key information DB in FIG. 5) for storing the encryption key linked to the encryption key setting information in the first storage means; and third storage means (for example, a package information DB in FIG. 5) for storing the package linked to the package setting information in the first storage means.

This information processing apparatus includes deleting means (for example, an input control unit 61 in FIG. 7) for, when the encryption key linked to the encryption key setting information in the first storage means has been deleted in the second storage means, deleting from the third storage means the package corresponding to the deleted encryption key linked to the package setting information in the first storage means, and generating means (for example, a package generation unit 62 in FIG. 7) for, when the package corresponding to the deleted encryption key has been deleted from the third storage means and a new encryption key has been stored in the second storage means instead of the deleted encryption key, generating a new package corresponding to the new encryption key linked to the encryption key setting information in the first storage means and storing the new package in the third storage means so as to be linked with the package setting information in the first storage means.

This information processing apparatus can further be provided with changing means (for example, a state change application 52 in FIG. 3) for changing information indicating whether or not the encryption key can be used.

This information processing apparatus can further be provided with responding means (for example, a request response unit 65 in FIG. 7) for responding to a request for use of the encryption key from a server for sending and receiving encrypted information to and from the IC chip, in accordance with the information indicating whether or not the encryption key can be used.

In an information processing method or a program according to an embodiment of the present invention, information processing for controlling a storage device is performed or a computer is caused to execute the information processing for controlling the storage device. The storage device has first storage means for storing encryption key setting information representing an encryption key used for sending and receiving encrypted information to and from an IC (Integrated Circuit) chip and package setting information representing a package having information concerning the encryption key, second storage means for storing the encryption key linked to the encryption key setting information in the first storage means, and third storage means for storing the package linked to the package setting information in the first storage means.

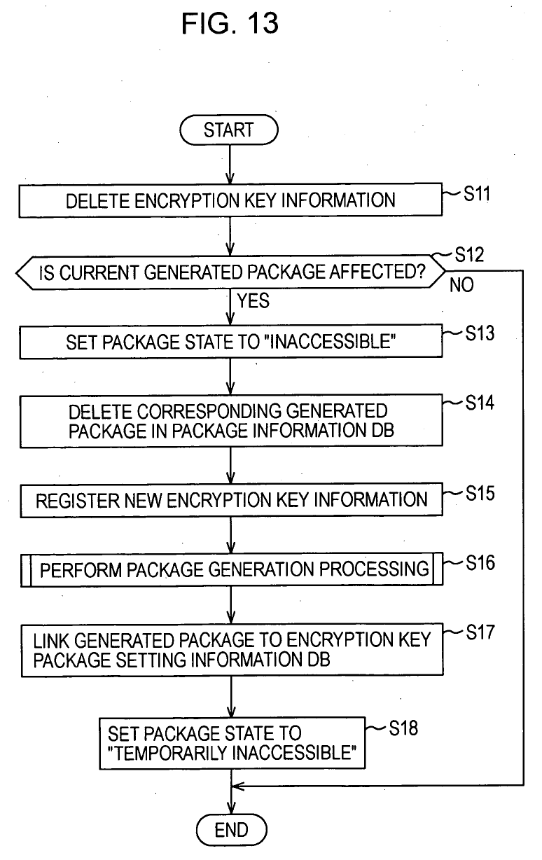

This information processing or program includes a step (for example, STEP S14 in FIG. 13) of, when the encryption key linked to the encryption key setting information in the first storage means has been deleted in the second storage means, deleting from the third storage means the package corresponding to the deleted encryption key linked to the package setting information in the first storage means, and a step (for example, STEP S16 in FIG. 13) of, when the package corresponding to the deleted encryption key has been deleted from the third storage means and a new encryption key has been stored in the second storage means instead of the deleted encryption key, generating a new package corresponding to the new encryption key linked to the encryption key setting information in the first storage means and storing the new package in the third storage means so as to be linked with the package setting information in the first storage means.

In the following, the preferred embodiments of the present invention will be described with reference to the accompanying drawings.

FIG. 3 illustrates an example of a configuration of a server-client system in which an embodiment of the present invention is implemented.

In this server-client system, the server apparatus 1, a Hardware Security Module (HSM) 2, and the key storage data base (DB) 7 are provided on the server side. A client apparatus 3 and a reader/writer (R/W) 4 are provided on the client side. The server apparatus 1 and the client apparatus 3 are connected via a network 5.

In proximity of the R/W 4 on the client side, a mobile phone device 6-1 containing a non-contact IC (Integrated Circuit) chip 13-1 and a card 6-2 containing a non-contact IC chip 13-2 (for example, a Suica™ card) are placed and connected to the client apparatus 3 via a short-range communication link using electromagnetic induction. In the following, when it is not necessary to discriminate between the non-contact IC chips 13-1 and 13-2, the non-contact IC chips 13-1 and 13-2 are simply referred to as the non-contact IC chip 13.

The server apparatus 1 includes a server application 11, a DB management application 51, and the state change application 52.

The server application 11 sends and receives a command to and from (communicates with) a client application 12. Such a command sent and received between the server application 11 and the client application 12 is encrypted using a transaction key shared between these applications. Specifically, the server application 11, when communicating with the client application 12, acquires from the key storage DB 7 a key which is identical to (or corresponds to) an encryption key stored in the non-contact IC chip 13. The server application 11 then provides the acquired key to the HSM 2 and requests the HSM 2 to generate a transaction key which is used for communication with the client application 12. Using the transaction key obtained from the HSM 2, the server application 11 encrypts a command to be sent to the non-contact IC chip 13 and decrypts an encrypted command received from the non-contact IC chip 13.

Thus, the server application 11 performs encryption and decryption of a command to be sent and received to and from the non-contact IC chip 13 using the transaction key provided by the HSM 2. This reduces load on the HSM 2 as compared with a case where the HSM 2 is used for encryption and decryption of a command, resulting in more efficient use of the HSM 2.

The DB management application 51 manages the encryption key package setting information DB, the encryption key information DB, and the package information DB which will be described below using FIG. 5.

The state change application 52 changes a package state which is information indicating whether or not a package (encryption key) of the non-contact IC chip 13 which is stored in the key storage DB 7 can be used.

For example, the DB management application 51 registers and updates an encryption key of the non-contact IC chip 13-1 in the key storage DB 7. The state change application 52 changes a package state indicative of whether or not the package of the non-contact IC chip 13-1 can be used. When the package state indicates that the package of the non-contact IC chip 13-1 can be used, the server application 11 can acquire the package (or encryption key) of the non-contact IC chip 13-1 from the key storage DB.

The key storage DB 7 is a storage device having a recording medium such as a hard disk and stores the encryption key package setting information DB, the encryption key information DB and the package information DB which will be described below. Information stored in the key storage DB 7 is encrypted by a key shared between the key storage DB 7 and the HSM 2.

The HSM 2 is a tamper-resistant device which performs mutual authentication with the non-contact IC chip 13 on the basis of a request for generation of a transaction key received from the server application 11 and provides the transaction key obtained as a result of the mutual authentication to the serve application 11. The HSM 2 also generates a package for each non-contact IC chip 13, such as an issuance package or a service registration package.

The client application 12 of the client apparatus 3 sends a predetermined request to the server application 11 of the server apparatus 1. Also, when a command is sent from the server application 11, the client application 12 sends the command to the non-contact IC chip 13 via the R/W 4 so that the command is executed.

The non-contact IC chip 13 decrypts an encrypted command sent from the client application 12 via the R/W 4 using the transaction key obtained through the mutual authentication with the HSM 2 and then executes the command.

In such a electronic money system having the configuration described above, for example, when the user of the mobile phone device 6-1 or the card 6-2 pays for a product using electronic money stored in the non-contact IC chip 13, the client application 12 of the client apparatus 3 sends a request for the payment for the product to the server application 11 of the server apparatus 1. Upon receiving the request, the server application 11 generates a command (a read command) for requesting the non-contact IC chip 13 to read a balance of electronic money.

The read command generated by the server application 11 is encrypted using the transaction key, and then sent to the non-contact IC chip 13 via the network 5, the client application 12 of the client apparatus 3, and the R/W 4. The non-contact IC chip 13 decrypts and executes the received read command. The balance read by the execution of the read command is encrypted by the non-contact IC chip 13 using the transaction key. Then, the encrypted balance is sent as a response to the server application 11 to the R/W 4, the client application 12 of the client apparatus 3, the network 5, and the server application 11 of the server apparatus 1. The server application 11 decrypts the encrypted balance sent form the non-contact IC chip 13, thus acquiring the balance of electronic money.

With this operation procedure, the server application 11 can check a current balance of electronic money stored in the non-contact IC chip 13.

After checking the balance, the server application 11 generates a command (a write command) for requesting the non-contact IC chip 13 to rewrite the balance of electronic money (writing of the balance obtained after the amount of the payment for the product is deducted).

Similarly to the read command described above, the write command generated by the server application 11 is encrypted using the transaction key. The encrypted command is then sent to the non-contact IC chip 13 via the network 5, the client application 12 of the client apparatus 3, and the R/W 4 so as to be decrypted and executed. This write command also contains information indicating the amount of the balance to be stored. This allows the non-contact IC chip 13 to store the balance of electronic money which is obtained after the payment amount is deducted.

For example, after processing, such as transmission of a message notifying the server application 11 that balance deduction of electronic money in the non-contact IC chip 13 has been completed, is performed, the processing procedure is terminated. Through such a processing procedure, payment for product purchase can be performed.

With the server-client system having the configuration described above, not only payment for product purchase, but also other processing can be carried out, such as management of points issued by a store and payment of toll or fare in a case where the client apparatus 3 is installed as an automatic ticket gate in a train station. Also in the case of point management or fare payment, a procedure basically similar to that performed for the product purchase described above is carried out by each component shown in FIG. 3.

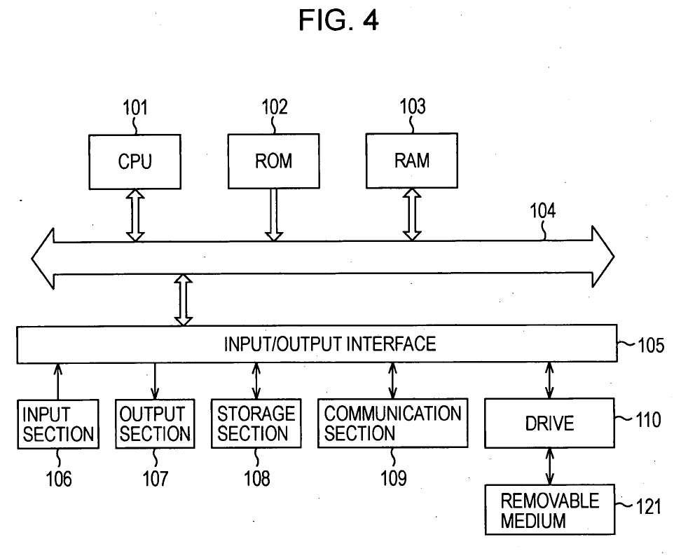

FIG. 4 is a block diagram illustrating an example of a hardware structure of the server apparatus 1.

A CPU (Central Processing Unit) 101 executes various processing in accordance with a program stored in a ROM (Read Only Memory) 102 or a storage section 108. A RAM (Random Access Memory) 103 stores data or a program to be executed by the CPU 101. The CPU 101, the ROM 102, and the RAM 103 are interconnected via a bus 104.

The CPU 101 is also connected to an input/output interface 105 via the bus 104. The input/output interface 105 is connected to an input section 106 constituted by a keyboard, a mouse, a microphone, etc., and an output section 107 constituted by a display, a speaker, etc. The CPU 101 performs various processing in accordance with an instruction sent from the input section 106 and sends the result of the processing to the output section 107.

The storage section 108 connected to the input/output interface 105 is constituted by, for example, a hard disk and stores data or a program to be executed by the CPU 101. A communication section 109 communicates with an external unit which is connected thereto directly or via a network such as the Internet or a local area network (LAN).

Note that the communication section 109 can communicate using either a wireless communication link or a wired communication link or can communicate using both wireless and wired communication links. Further, a communication scheme employed in the communication section 109 is not limited to a specific one, and various communication schemes can be employed such as, in the case of wireless communication, a wireless LAN such as IEEE (The Institute of Electrical and Electronic Engineers) 802.11a, 802.11b, and 802.11g and Bluetooth. Also in the case of wired communication, various wired communication schemes can be employed in the communication section 109, such as IEEE1394, Ethernet™ and USB (Universal Serial Bus).

A drive 110 connected to the input/output interface 105, when mounted with a removable medium 121 such as a magnetic disk, an optical disk, a magneto-optical disk, or a semiconductor memory, drives the removable medium 121 and acquires a program or data recorded thereon. The acquired program or data is transferred to the storage section 108 and stored therein according to need. A program or data can also be acquired through the storage section 109 and stored in the storage section 108.

In the server apparatus 1 having the configuration described above, for example, programs of the server application 11, the DB management application 51, and the state change application 52 stored in the storage section 108 are temporarily loaded (stored) in the RAM 103 so as to be executed by the CPU 101.

In this embodiment, all of the server application 11, the DB management application 51, and the state change application 52 are executed by a single unit of the server apparatus 1. However, the server application 11, the DB management application 51, and the state change application 52 can be executed separately using different apparatuses such as computers.

FIG. 5 illustrates an example of the encryption key package setting information DB, the encryption key information DB, and the package information DB stored in the key storage DB 7.

The encryption key package setting information DB stores encryption key package setting information for each non-contact IC chip 13 with which the server application 11 communicates. Specifically, the encryption key package setting information DB stores, for each non-contact IC chip 13, setting items of “package type”, “associated area”, “associated service”, “state”, and “package” and setting values corresponding to the setting items. The setting items of “package type”, “associated area”, and “associated service” are information necessary for generating a package and thus referred to as package generation information. In addition, each of the setting items of “associated area” and “associated service” is information representing an encryption key of the non-contact IC chip 13. The setting item “package” is package setting information representing a package.

As a setting value for the setting item of “package type”, information is input which is indicative of the type of package generated using the package generation information. The type of package includes the above-mentioned “issuance package” or “service registration package”.

As a setting value for the setting item of “associated area”, information is input which is indicative of an encryption key stored in the space of “Area” of the non-contact IC chip 13 and in the encryption key information DB. As a setting value for the setting item of “associated service”, information is input which is indicative of an encryption key stored in the space of “Service” of the non-contact IC chip 13 and in the encryption key information DB.

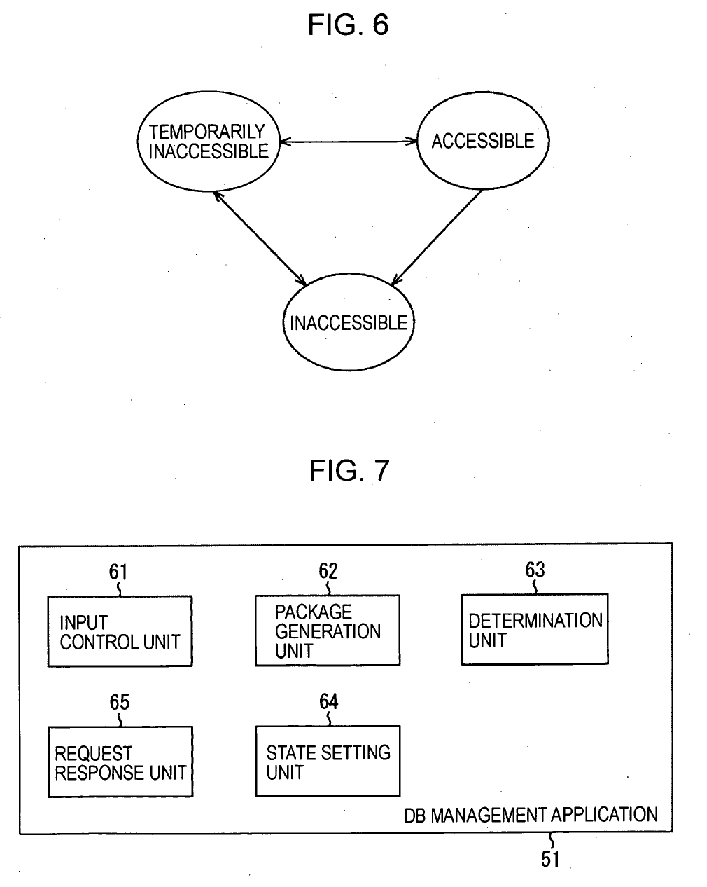

As a setting value for the setting item of “state”, package state information is input which is indicative of whether or not a package in the non-contact IC chip 13 can be used. Such package state information includes “temporarily inaccessible”, “accessible”, and “inaccessible”, which will be described below with reference to FIG. 6.

As a setting value for the setting item of “package”, information is input which is indicative of a package which is generated on the basis of the package generation information and stored in the package information DB.

In the example shown in FIG. 5, the encryption key package setting information DB stores, as information associated with the non-contact IC chip 13-1, setting values of “issuance package”, “Area 1”, “Service 1”, “temporarily inaccessible”, and “package 1” which correspond to the setting items of “package type”, “associated area”, “associated service”, “state”, and “package”, respectively.

In addition, the encryption key package setting information DB stores, as information associated with the non-contact IC chip 13-2, setting values of “issuance package”, “Area 2”, “Service 2”, “temporarily inaccessible”, and “package 2” which correspond to the setting items of “package type”, “associated area”, “associated service”, “state”, and “package”, respectively.

The encryption key information DB stores information on an encryption key in the non-contact IC chip 13. Specifically, the encryption key information DB stores an encryption key in the non-contact IC chip 13 and information for identifying the encryption key (encryption key identification information) which are associated with each other.

In the example shown in FIG. 5, the encryption key information DB stores “encryption key 1” corresponding to encryption key identification information “System”, “encryption key 2” corresponding to encryption key identification information “Area 1”, and “encryption key 3” corresponding to encryption key identification information “Service 1”. In addition, the encryption key information DB stores “encryption key 4” corresponding to encryption key identification information “Area 2” and “encryption key 5” corresponding to encryption key identification information “Service 2”.

Further, it is configured such that an encryption key stored in the encryption key information DB is linked to the setting item “associated area” in any of the non-contact IC chips 13 stored in the encryption key package setting information DB. This configuration is achieved by providing corresponding encryption key identification information the same name as the setting value of the setting item “associated area” in the encryption key package setting information DB.

Specifically, “encryption key 2” having the encryption key identification information “Area 1” in the encryption key information DB is linked to the setting item “associated area” whose corresponding setting value is “Area 1” in the non-contact IC chip 13-1 in the encryption key package setting information DB. “encryption key 3” having the encryption key identification information “Service 1” in the encryption key information DB is linked to the setting item “associated service” whose corresponding setting value is “Service 1” in the non-contact IC chip 13-1 in the encryption key package setting information DB. Likewise, “encryption key 4” having the encryption key identification information “Area 2” in the encryption key information DB is linked to “associated area” whose corresponding setting value is “Area 2” in the non-contact IC chip 13-2 in the encryption key package setting information DB. “encryption key 5” having the encryption key identification information “Service 2” in the encryption key information DB is linked to “associated service” whose corresponding setting value is “Service 2” in the non-contact IC chip 13-2 in the encryption key package setting information DB.

This configuration results in a state equivalent to the state in which, in the encryption key package setting information DB, “encryption key 2” is set (input) as the setting value of the setting item “associated area” in the non-contact IC chip 13-1. The above arrangement also brings about a state equivalent to the state in which, in the encryption key package setting information DB, “encryption key 3” is set as the setting value of the setting item “associated service” in the non-contact IC chip 13-1. The same is true for “associated area” and “associated service” in the non-contact IC chip 13-2.

On the other hand, the package information DB stores package information of the non-contact IC chip 13. Specifically, the package information DB stores a package in the non-contact IC chip 13 and information for identifying the package (package identification information) which are associated with each other.

In the example of FIG. 5, the package information DB stores “issuance package A” corresponding to package identification information “package 1” and “issuance package B” corresponding to package identification information “package 2”.

It is configured such that a package stored in the package information DB is linked to the setting item “package” in any of the non-contact IC chips 13 stored in the encryption key package setting information DB. This configuration is achieved by providing corresponding package identification information the same name as the setting value of the setting item “package” in the encryption key package setting information DB.

Specifically, “issuance package A” having the package identification information “package 1” in the package information DB is linked to the setting item “package” whose corresponding setting value is “package 1” in the non-contact IC chip 13-1 in the encryption key package setting information DB. Similarly, “issuance package B” having the package identification information “package 2” in the package information DB is linked to the setting item “package” whose corresponding setting value is “package 2” in the non-contact IC chip 13-2 in the encryption key package setting information DB.

This configuration results in a state equivalent to the state in which, in the encryption key package setting information DB, “issuance package A” is set as the setting value of the setting item “package” in the non-contact IC chip 13-1. The above arrangement also brings about a state equivalent to the state in which, in the encryption key package setting information DB, “issuance package B” is set as the setting value of the setting item “package” in the non-contact IC chip 13-2.

“issuance package A” linked to the setting item “package” of the non-contact IC chip 13-1 is a package which has been generated (hereinafter also referred to as a generated package). To generate “issuance package A”, the DB management application 51 requests the HSM 2 for the generation of the package by providing the HSM 2 the package type “issuance package”, “encryption key 1” corresponding to “System”, and “encryption key 2” corresponding to “Area 1”.

As described above, in the key storage DB 7, the encryption key package setting information DB stores the setting items “package type”, “associated area”, “associated service”, “state”, and “package” and corresponding setting values, for each non-contact IC chip 13 with which the server apparatus 1 communicates.

The encryption key information DB stores encryption keys each of which are linked to the individual setting items “associated area” and “associated service” of the non-contact IC chip 13. The package information DB stores a generated package which is linked to the setting item “package” of the non-contact IC chip 13.

In this embodiment, it is assumed that only one type of “System” is applied, and every non-contact IC chip 13 uses “encryption key 1” corresponding to a single “System”. Thus, “encryption key 1” in the encryption key information DB is used as the encryption key stored in the space of “System” in the non-contact IC chip 13, without the necessity of preparing a setting item for setting an encryption key corresponding to “System” for each non-contact IC chip 13 in the encryption key package setting information DB. On the other hand, when the server application 11 handles a plurality of “Systems”, for example, a setting item “associated system” can be prepared in addition to the setting items “associated area” and “associated service” of the non-contact IC chip 13 in the encryption key package setting information DB. Then, this setting item “associated system” can be linked to “encryption key 1” corresponding to “System” stored in the encryption key information DB.

Further, in this embodiment, as described above, an encryption key stored in the encryption key information DB is linked to a setting item in the encryption key package setting information DB by providing corresponding encryption key identification information the same name as the setting value of the setting item in the encryption key package setting information DB. However, the setting value in the encryption key package setting information DB and the encryption key identification information in the encryption key information DB do not necessarily have the same name. The setting value and the encryption key identification information can be named differently. In this case, new link information can be provided which represents the encryption key identification information in the encryption key information DB which is linked to the setting item in the encryption key package setting information DB.

FIG. 6 illustrates states indicative of whether or not a package can be used. These states can be set as setting values corresponding to the setting item “state” of the non-contact IC chip 13 in the encryption key package setting information DB (hereinafter also referred to as a package state).

As shown in FIG. 6, three types of package states can be set as the setting values corresponding to the setting item “state” in the encryption key package setting information DB: “temporarily inaccessible”, “inaccessible”, and “accessible”.

When certain encryption key package setting information of the non-contact IC chip 13 is registered in the encryption key package setting information DB for the first time, the DB management application 51 sets the setting value corresponding to the setting item “state” of the non-contact IC chip 13 to “temporarily inaccessible”. This package state of “temporarily inaccessible” indicates a state in which information necessary for communicating with the non-contact IC chip 13 (encryption keys corresponding to the conceptual areas of “System” “Area” and “Service” and a package) is registered in the key storage DB 7, but communication with the non-contact IC chip 13 is not permitted. This package state is set in a case, for example, where a registration state of an encryption key or a package is checked before the server application 11 actually communicates with the non-contact IC chip 13 or where use of an encryption key (use of a service) is desired to be discontinued after the use of the encryption key is initiated.

When use of an encryption key is intended to be initiated under the package condition of “temporarily inaccessible”, i.e., communication between the non-contact IC chip 13 and the server application 11 is permitted, the state change application 52 sets (changes) the setting value of setting item “state” in the non-contact IC chip 13 to “accessible”. The state change application 52 can change the setting value of the setting item “state” in the non-contact IC chip 13 from “temporarily inaccessible” to “accessible” as well as from “accessible” to “temporarily inaccessible”.

When a generated package in the package information DB which is linked to the setting item “package” in the non-contact IC chip 13 is deleted while the package state of the non-contact IC chip 13 is “accessible” or “temporarily inaccessible”, the package state in the non-contact IC chip 13 is changed to “inaccessible”. The package state of the non-contact IC chip 13 is changed from the “inaccessible” to “temporarily inaccessible” when a generated package in the non-contact IC chip 13 is registered (stored) in the package information DB and also linked to the setting item “package” of the non-contact IC chip 13 in the encryption key package setting information DB. Then, the package state of the non-contact IC chip 13 is changed from “temporarily inaccessible” to “accessible” after a check of the registration state, for example, is performed according to need.

An example of a functional configuration of the DB management application 51 is illustrated in a block diagram of FIG. 7.

The DB management application 51 includes the input control unit 61, the package generation unit 62, a determination unit 63, a request response unit 64, and the state setting unit 65.

The input control unit 61 registers (stores) the encryption key package setting information or the encryption key information of the non-contact IC chip 13 in the encryption key package setting information DB or the encryption key information DB, on the basis of a user operation.

Specifically, the input control unit 61 registers in the encryption key package setting information DB package generation information for a new non-contact IC chip 13 which has been input by a user operation. The input control unit 61 also registers each encryption key stored in the space of “Area” or “Service” of the new non-contact IC chip 13 in the encryption key information DB. Then, the input control unit 61 links the registered encryption key to the setting item of “associated area” or “associated service” in the encryption key package setting information DB by providing the encryption key identification information of the registered encryption key the same name as the setting value of the setting items “associated area” or “associated service”. In addition, the input control unit 61 is capable of updating an encryption key of the non-contact IC chip 13 registered in the encryption key information DB on the basis of a user operation.

The package generation unit 62 generates a package (generated package) when no generated package linked to the setting item “package” in each the non-contact IC chip 13 in the encryption key setting information DB is registered in the package information DB. To be more specific, the HSM 2 actually generates the package on the basis of the package generation information. Therefore, the package generation unit 62 acquires necessary package generation information (including an encryption key linked thereto) to request the HSM 2 to generate the package. The package generation unit 62 then receives the package generated by the HSM 2 (generation package) and registers the generated package in the package information DB. Then, the package generation unit 62 links the generated package registered in the package information DB to the setting item “package” in the encryption key package setting information DB.

The determination unit 63 determines, when an encryption key stored in the encryption key information DB is deleted, whether or not the deletion of the encryption key affects a generated package currently registered in the package information DB. Specifically, a generated package is generated on the basis of an encryption key corresponding to the space of “System”, “Area”, or “Service”, as described above. Therefore, when the encryption key which is used for generating the generated package is deleted, the generated package is affected. Accordingly, if the deletion of the encryption key affects the generated package currently registered in the package information DB, the determination unit 63 notifies the input control unit 61 and the state setting unit 64 that the encryption key has been deleted which affects the generated package.

Then, the input control unit 61 deletes from the package information DB the generated package which is linked to the setting item “package” of the non-contact IC chip 13 from which the encryption key has been deleted. The state setting unit 64 then sets the setting value of the setting item “state” of the non-contact IC chip 13 to “inaccessible”.

The state setting unit 64 sets the setting value of the setting item “state” (package state) of each non-contact IC chip 13 in the encryption key package setting information DB. For example, when encryption key package setting information for a new non-contact IC chip 13 is registered, the state setting unit 64 sets the setting value of the setting item “state” of the new non-contact IC chip 13 to “temporarily inaccessible”. Further, for example, when a notification is provided from the determination unit 63 which indicates that an encryption key which affects a generated package in the non-contact IC chip 13 has been deleted, the state setting unit 64 sets the setting value of the setting item “state” of the non-contact IC chip 13 to “inaccessible”.

When a request for use of a package (generated package) of any non-contact IC chip 13 is provided from the server application 11, the request response unit 65 responds to the request in accordance with the package state of the non-contact IC chip 13. Specifically, when the setting value of the setting item “state” of the non-contact IC chip 13 storing the requested package is “temporarily inaccessible” or “inaccessible”, the request response unit 65 replies with “inaccessible” for the package use request sent from the server application 11. On the other hand, when the setting value of the setting item “state” of the non-contact IC chip 13 containing the requested package is “accessible”, the request response unit 65 replies with the requested package of the non-contact IC chip 13 for the package use request sent from the server application 11.

Now, an operation procedure performed when various information of the non-contact IC chip 13 is registered in the key storage DB 7 will be illustrated using the example of data in the non-contact IC chip 13-1 shown in FIG. 5.

The input control unit 61 first registers the encryption key package setting information of the non-contact IC chip 13-1 in the encryption key package setting information DB. Specifically the input control unit 61 sets the setting values of the setting items “package type”, “associated area”, and “associated service” of the non-contact IC chip 13-1 to “issuance package”, “Area 1”, and “Service 1”, respectively. Then, the input control unit 61 registers in the encryption key information DB “encryption key 2” and “encryption key 3” stored in the spaces of “Area” and “Service” of the non-contact IC chip 13-1, respectively. The input control unit 61 then sets the encryption key identification information of “encryption key 2” as “Area 1” which is the same as the setting value of the setting item “associated area” of the non-contact IC chip 13-1, so as to link “encryption key 2” to the setting item of the non-contact IC chip 13-1. Similarly, the input control unit 61 sets the encryption key identification information of “encryption key 3” as “Service 1” which is the same as the setting value of the setting item “associated service” of the non-contact IC chip 13-1, so as to link “encryption key 3” to the setting item of the non-contact IC chip 13-1.

The package generation unit 62 acquires “encryption key 1” corresponding to “System” and “encryption key 2” corresponding to “Area 1” of the non-contact IC chip 13-1 and requests the HSM 2 to generate a package corresponding to the package type “issuance package”. Then, the package generation unit 62 registers the generated package “issuance package A”, which is provided by the HSM 2 in response to the package generation request, in the package information DB. The package generation unit 62 also sets the package identification information of the generated “issuance package A” as “package 1” which is the same as the setting value of the setting item “package” of the non-contact IC chip 13-1 so as to link the “issuance package A” to the setting item of the non-contact IC chip 13-1.

Subsequently, the state setting unit 64 sets the setting value of the setting item “state” of the non-contact IC chip 13-1 to “temporarily inaccessible”.

Through the above procedure, information necessary for communicating with the non-contact IC chip 13-1 is registered (stored) in the encryption key package setting information DB, the encryption key information DB, and the package information DB in the key storage DB 7.

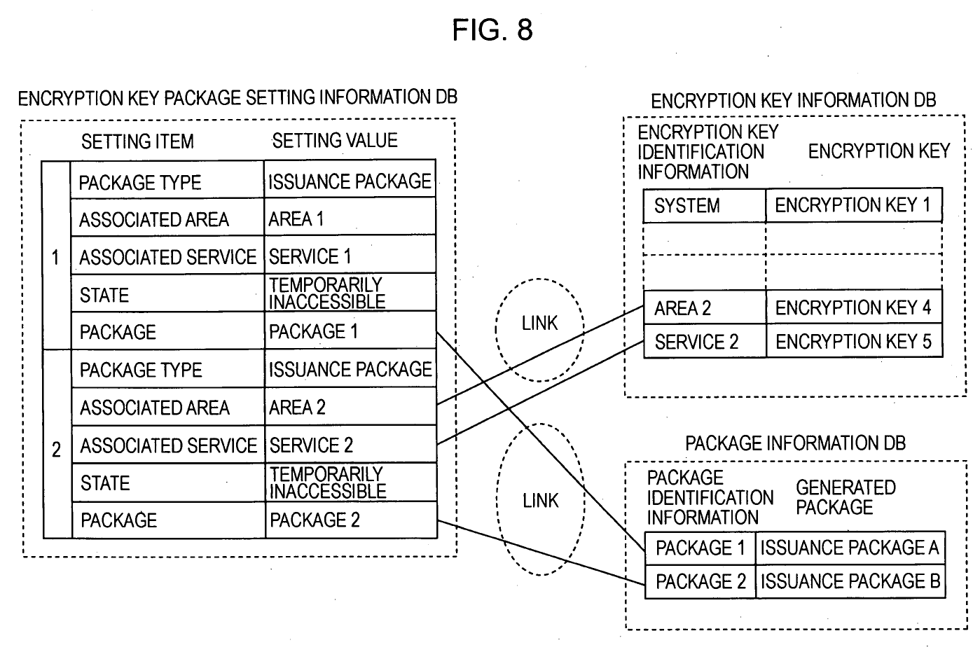

Referring now to FIG. 8 to FIG. 12, package update processing will be described, in which the DB management application 51 updates (changes) a generated package when “encryption key 2” and “encryption key 3” stored in the spaces of “Area 1” and “Service 1” of the non-contact IC chip 13-1 into “encryption key 8” and “encryption key 9”.

The input control unit 61 first deletes from the encryption key information DB “encryption key 2” and “encryption key 3” which are common to those stored in the spaces of “Area 1” and “Service 1” of the non-contact IC chip 13-1, in accordance with a user operation, as shown in FIG. 8.

The determination unit 63 determines whether or not the deletion of “encryption key 2” and “encryption key 3” from the encryption key information DB affects a generated package currently registered in the package information DB. Since “issuance package A” generated on the basis of the “encryption key 2” needs to be changed due to the deletion of the “encryption key 2” and “encryption key 3, the determination unit 63 notifies the input control unit 61 and the state setting unit 64 that an encryption key which affects an generated package has been deleted.

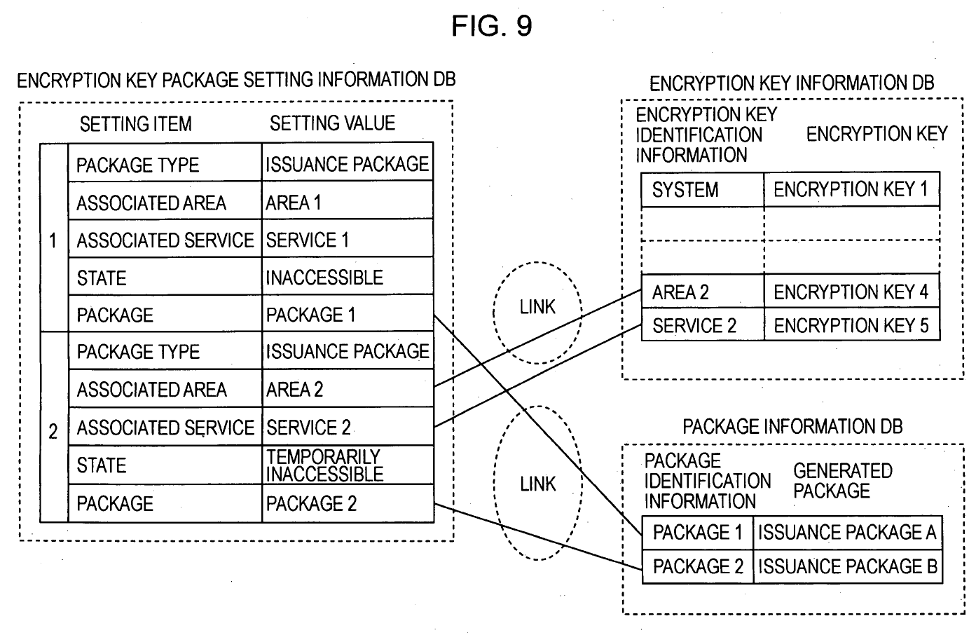

The state setting unit 64 then sets (changes) the setting value of the setting item “state” of the non-contact IC chip 13-1 to (the package state of) “inaccessible” as shown in FIG. 9.

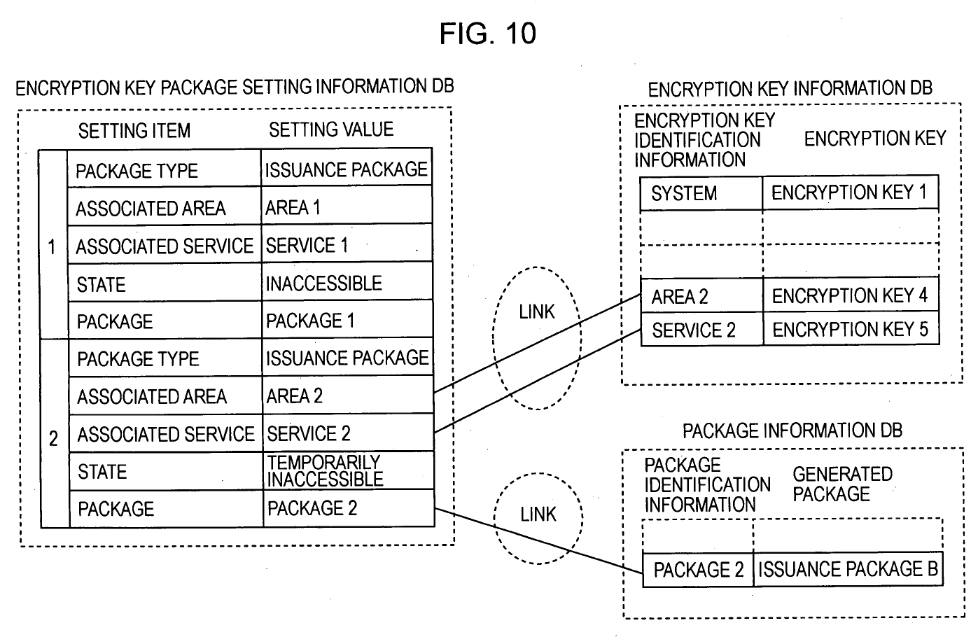

The input control unit 61 deletes “issuance package A” in the package information DB, as shown in FIG. 10.

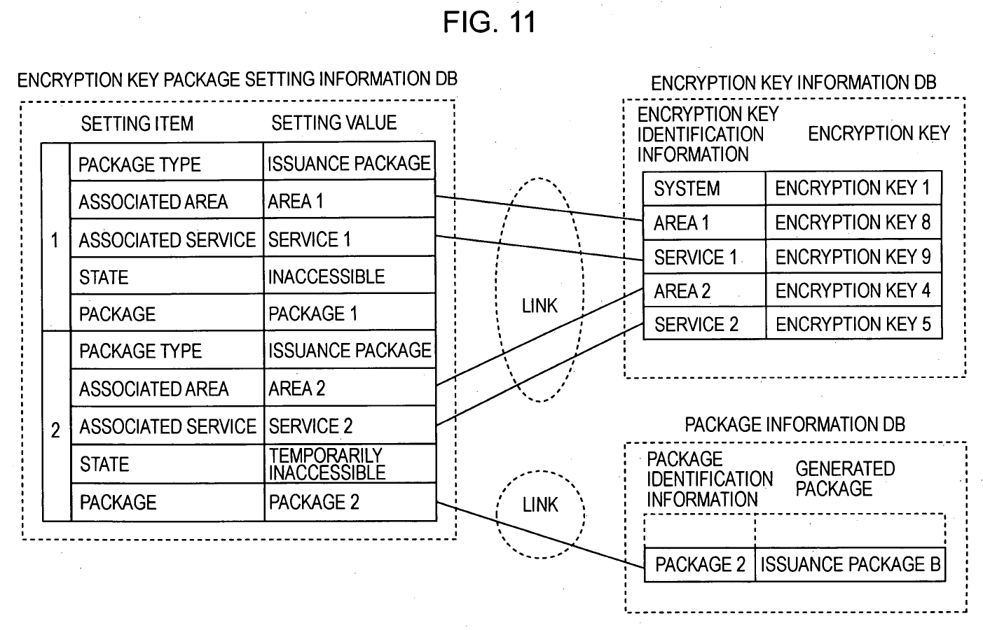

Then, the input control unit 61 registers newly input “encryption key 8” and “encryption key 9” in the encryption key information DB as encryption keys to be stored in the spaces of “Area 1” and “Service 1” of the non-contact IC chip 13-1, respectively, as shown in FIG. 11.

In addition, the input control unit 61 sets the encryption key identification information of “encryption key 8” as “Area 1” which is the same as the setting value of the setting item “associated area” of the non-contact IC chip 13-1. The input control unit 61 also sets the encryption key identification information of “encryption key 9” as “Service 1” which is the same as the setting value of the setting item “associated service” of the non-contact IC chip 13-1. Thus, the input control unit 61 links the encryption keys to the setting items, as shown in FIG. 11.

The package generation unit 62 detects that the package information DB contains no generated package which is linked to the setting item “package” of the non-contact IC chip 13-1 in the encryption key package setting information DB. Thus, the package generation unit 62 generates a package and registered the generated package in the package information DB.

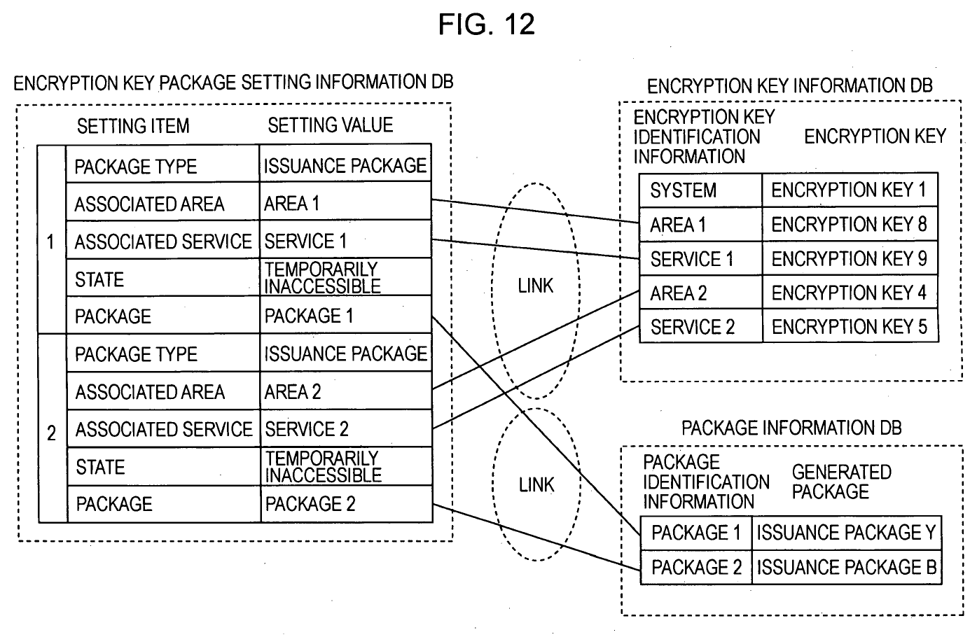

Specifically, the package generation unit 62 sends the HSM 2 a package generation request by providing the HSM 2 “issuance package” corresponding to “package type” of the non-contact IC chip 13-1 as well as “encryption key 1” and “encryption key 8” corresponding to the spaces of “System” and “Area 1”, respectively. Thus, the package generation unit 62 acquires “issuance package Y” and registers this “issuance package Y” in the package information DB. The package generation unit 62 sets the package identification information of “issuance package Y” as “package 1” which is the same as the setting value of the setting item “package” of the non-contact IC chip 13-1 in the encryption key package setting information DB. Thus, the package generation unit 62 links the “issuance package Y” to the setting item “package” of the non-contact IC chip 13-1, as shown in FIG. 12.

Through this operation procedure described above, when “encryption key 2” and “encryption key 3” of the non-contact IC chip 13-1 are updated into “encryption key 8” and “encryption key 9”, the generated package “issuance package A” of the non-contact IC chip 13-1 in the key storage DB 7 is updated into “issuance package Y”.

Referring to a flowchart in FIG. 13, the package update processing procedure performed in the DB management application 51 will be described in more detail. Also in FIG. 13, an example of a case will be described in which “encryption key 2” and “encryption key 3” stored in the spaces of “Area 1” and “Service 1” of the non-contact IC chip 13-1 are updated (changed) into “encryption key 8” and “encryption key 9”, respectively.

When “encryption key 2” and “encryption key 3” which are the same as those stored in the spaces of “Area 1” and “Service 1” of the non-contact IC chip 13-1 are deleted from the encryption key information DB by a user operation (input), the input control unit 61 deletes the encryption key information of the non-contact IC chip 13-1 from the encryption key information DB, at STEP S11. Specifically, the input control unit 61 deletes from the encryption key information DB “encryption key 2” and “encryption key 3” of the non-contact IC chip 13-1 in the encryption key package setting information DB.

At STEP S12, the determination unit 63 determines whether or not the deletion of “encryption key 2” and “encryption key 3” affects any generated package of the non-contact IC chip 13 which is currently registered in the package information DB. If, in STEP S12, it is determined that the deletion does not affect the current generated package, the processing procedure is terminated.

On the other hand, if, in STEP S12, it is determined that the deletion affects the current generated package, the processing procedure proceeds to STEP S13. The determination unit 63 provides the input control unit 61 and the state setting unit 64 a notification that an encryption key which affects the generated package has been deleted. Then, the state setting unit 64 sets the setting value of the setting item “state” of the non-contact IC chip 13-1 to “inaccessible”, at STEP S13.

At STEP S14, the input control unit 61 deletes the package to be affected in the package information DB. Specifically, in STEP S14, the input control unit 61 deletes “issuance package A” in the package information DB which is linked to the setting item “package” of the non-contact IC chip 13-1.

At STEP S15, the input control unit 61 registers new encryption key information in the encryption key information DB. Specifically, the input control unit 61 stores in the encryption key information DB “encryption key 8” and “encryption key 9” input by a user operation which are to be stored in the spaces of “Area 1” and “Service 1” of the non-contact IC chip 13-1, respectively. The input control unit 61 sets the encryption key identification information of “encryption key 8” and “encryption key 9” as “Area 1” and “Service 1”, respectively, which are the same as the setting values of the setting items “associated area” and “associated service” of the non-contact IC chip 13-1, respectively, in the encryption key package setting information DB, so as to link these encryption keys to the setting items of the non-contact IC chip 13-1.

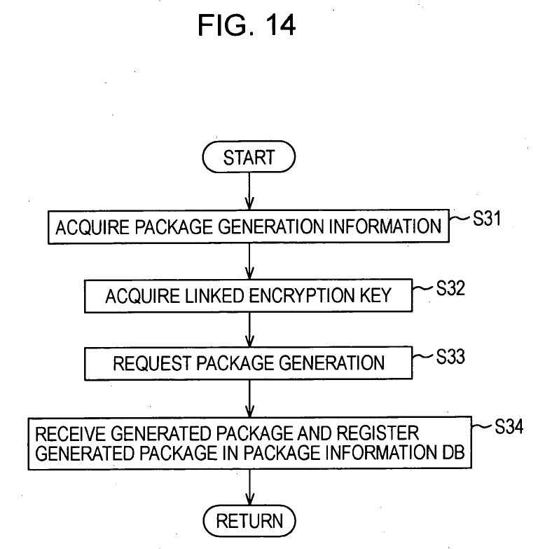

At STEP S16, the package generation unit 62 detects the absence of the generated package in the package information DB which is linked to the setting item “package” of the non-contact IC chip 13-1 in the encryption key package setting information, and executes package generation processing. This package generation processing will be described with reference to FIG. 14. With the package generation processing, a new generation package “issuance package Y” for the non-contact IC chip 13-1 is registered in the package information DB.

At STEP S17, the package generation unit 62 sets the package identification information of “issuance package Y” registered in the package information DB as “package 1” which is the same as the setting value of the setting item “package” of the non-contact IC chip 13 in the encryption key package setting information, so as to link the “issuance package Y” in the package information DB to the setting item “package” in the encryption key package setting information DB.

At STEP S18, the state setting unit 64 sets the package state of the non-contact IC chip 13-1 to “temporarily inaccessible”, and the processing procedure is terminated. Specifically, the state setting unit 64 sets the setting value of the setting item “state” of the non-contact IC chip 13-1 in the encryption key package setting information DB to “temporarily inaccessible” and then terminates the processing procedure.

Referring to a flowchart of FIG. 14, a procedure of the package generation processing of STEP S15 in FIG. 13 will be described.

At STEP S31, the package generation unit 62 first acquires package generation information of the non-contact IC chip 13-1, i.e., the setting values of the setting items “package type” “associated area” and “associated service”, and the processing procedure proceeds to STEP S32.

At STEP S32, the package generation unit 62 acquires from the encryption key information DB “encryption key 8” which is linked to the setting item “associated area” of the non-contact IC chip 13-1. The package generation unit 62 also acquires from the encryption key information DB “encryption key 1” stored in the space of “System” in the non-contact IC chip 13-1.

Then, at STEP S33, the package generation unit 62 provides the HSM 2 “issuance package” representing “package type” as well as “encryption key 1” and “encryption key 8” corresponding to “System” and “Area 1” so as to request the HSM 2 for package generation.

At STEP S34, the package generation unit 62 receives the generated “issuance package Y” from the HSM 2 and registers “issuance package Y” in the package information DB. Then, the processing procedure proceeds to STEP S17 in FIG. 13.

As described above, when “encryption key 2” and “encryption key 3” which are linked to the setting items “associated area” and “associated service” of the non-contact IC chip 13-1, respectively are deleted in the encryption key information DB, the determination unit 63 determines whether or not the deletion of the “encryption key 2” and “encryption key 3” affects the generated package in the non-contact IC chip 13-1.

Then, if it is determined that the deletion of “encryption key 2” and “encryption key 3” affects the generated package in the non-contact IC chip 13-1, the input control unit 61 deletes from the package information DB the generated package “issuance package A” corresponding to the deleted “encryption key 2” and “encryption key 3”. The state setting unit 64 sets (changes) the setting value of the setting item “state” of the non-contact IC chip 13-1 to (the package state of) “inaccessible”.

When “issuance package A” corresponding to the deleted “encryption key 2” and “encryption key 3” has been deleted form the package information DB, and “encryption key 8” and “encryption key 9” have been stored in the encryption key information DB as new encryption keys for the spaces of “Area 1” and “Service 1” of the non-contact IC chip 13-1, the package generation unit 62 newly generates “issuance package Y” and registers (stores) “issuance package Y” in the package information DB so as to be linked with the setting item “package” in the encryption key package setting information DB.

Thus, in the key storage DB 7, (an entity of) an encryption key of the non-contact IC chip 13-1 or a generated package is stored in the encryption key information DB or the package information DB which is independent of the encryption key package setting information DB which stores setting information for the non-contact IC chip 13-1. This indicates that even when the encryption key is changed, information which has been stored in the encryption key package setting information DB can be retained, and only information which needs to be changed due to the change of the encryption key is updated. As a result, an operation for reregistering information which needs not to be changed can be omitted.

Accordingly, the server-client system shown in FIG. 3 advantageously allows an encryption key or a generated package for the non-contact IC chip 13 to be stored in the key storage DB 7. In addition, the server-client system facilitates changing of the encryption key or the generated package stored in the key storage DB 7 which is provided to the non-contact IC chip 13.

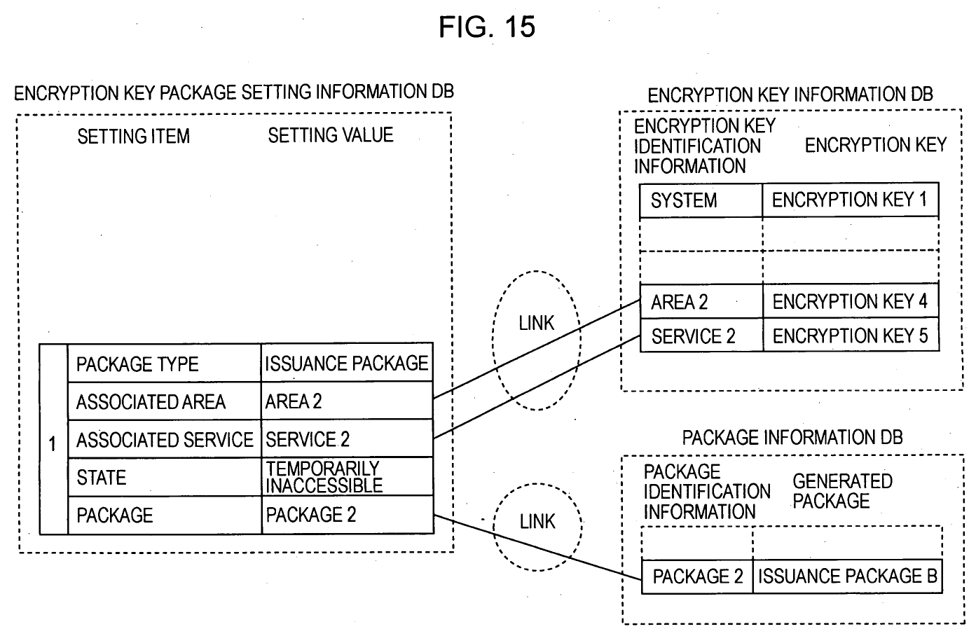

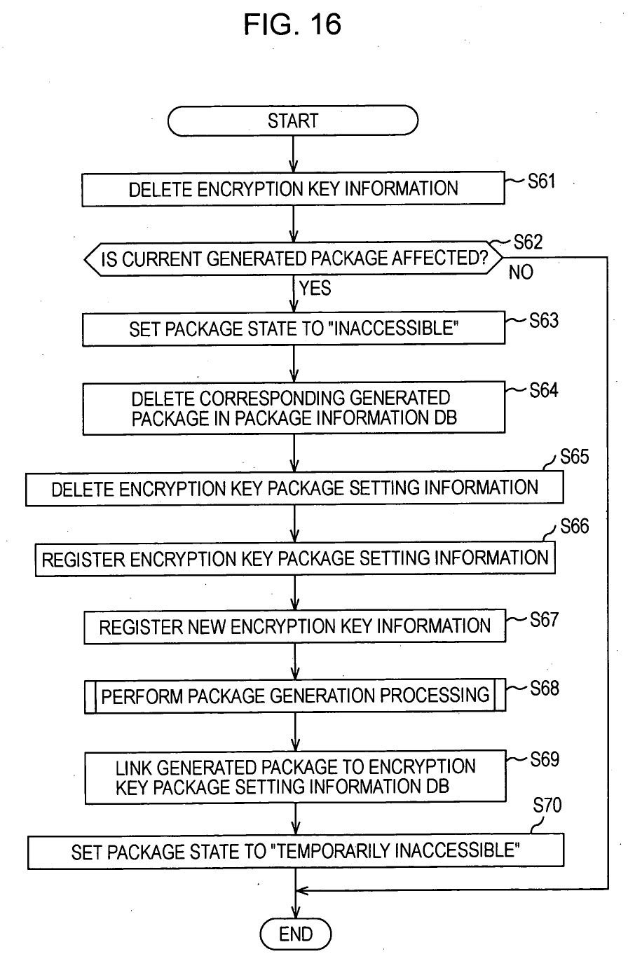

In addition, the DB management application 51, when receiving from the determination unit 63 a notification that “encryption key 2” and “encryption key 3” which affect the current generated package has been deleted, can temporarily delete all encryption key package setting information in the non-contact IC chip 13-1 which has stored the “encryption key 2” and “encryption key 3”, as shown in FIG. 15. Package update processing performed in this case can be executed in accordance with a flowchart of FIG. 16.

Processing of STEP S61 to STEP S64 in FIG. 16 is the same as that of STEP S11 to STEP S14 in FIG. 13, and a description thereof will be omitted.

Subsequently to the processing of STEP S64, the input control unit 61 deletes encryption key package setting information of the non-contact IC chip 13-1 in the encryption key package setting information DB, at STEP S65.

At STEP S66, the input control unit 61 reregisters encryption key package setting information of the non-contact IC chip 13-1 in the encryption key package setting information DB.

Processing of STEP S67 to STEP S70 is the same as that of STEP S15 to STEP S18 in FIG. 13, and a description thereof will be omitted.

It is possible to select between the package update processing of FIG. 13 and the package update processing of FIG. 16 by switching modes, for example. In both processing, information consequently stored in the key storage DB 7 is the same. However, in the package update processing of FIG. 16, it is necessary to generate information identical to deleted information and register the generated information again in the encryption key package setting information DB. This brings about an increased amount of the processing as compared with the package update processing of FIG. 13. Therefore, the package update processing of FIG. 13 is more desirable which permits a reduced amount of processing for information storage.

In the package update processing of the FIG. 13 and FIG. 16, when “encryption key 8” and “encryption key 9” are newly registered in the encryption key information DB instead of the deleted “encryption key 2” and “encryption key 3”, it is configured such that new “issuance package Y” for the non-contact IC chip 13-1 which substitutes for these deleted encryption keys is immediately generated.

However, a package corresponding to “encryption key 8” and “encryption key 9” is not necessarily generated immediately after these encryption keys of the non-contact IC chip 13-1 are registered. The package can also be generated at a timing designated by a user.

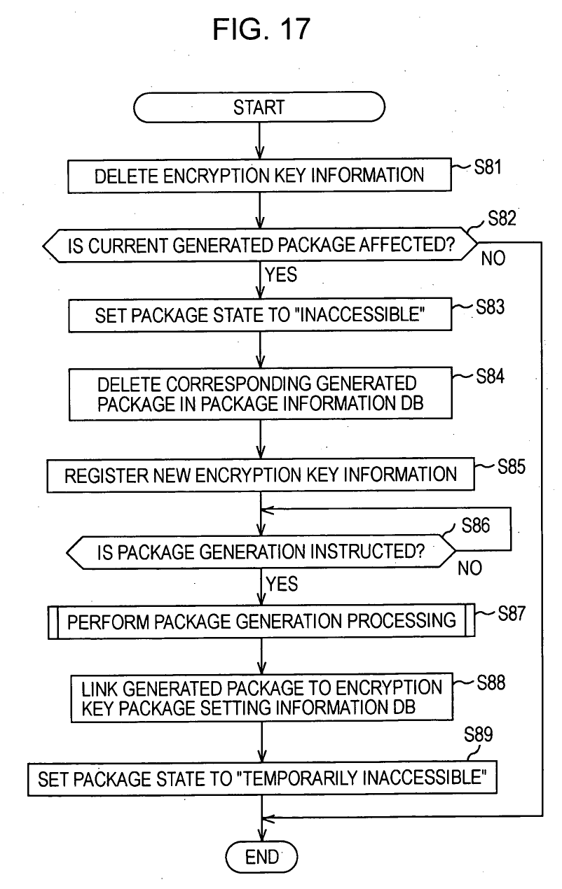

FIG. 17 is a flowchart illustrating a procedure of such package update processing, in which a generated package is not immediately updated in response to a change in an encryption key, but is updated at a timing designated by a user (user operation).

As shown in the figure, processing from STEP S81 to STEP S89 except processing of STEP 86 is the same as that from STEP S11 to S18 in FIG. 13. Specifically, the processing of S81 to S85 in FIG. 17 corresponds to the processing of S11 to S15 in FIG. 13, and the processing of S87 to S89 in FIG. 17 corresponds to the processing of STEP S16 to S18 in FIG. 13.

In STEP S81 to S85, “encryption key 2” and “encryption key 3” linked to the setting item “associated area” and “associated service” of the non-contact IC chip 13-1 in the encryption key package setting information DB are deleted from the encryption key information DB. Along with the deletion of these encryption keys, “issuance package A” which is a generated package corresponding to the deleted encryption keys of the non-contact IC chip 13-1 is also deleted form the package information DB. Then, “encryption key 8” and “encryption key 9” substituting for “encryption key 2” and “encryption key 3” are registered in the encryption key information DB.

At STEP S86, the input control unit 61 determines whether or not an instruction of generation of package corresponding to the newly registered “encryption key 8” and “encryption key 9” has been provided by the user. The input control unit 61 waits until it is determined that the package generation instruction has been provided by the user.

If, in STEP S86, it is determined that the instruction of generation of the package corresponding to “encryption key 8” and “encryption key 9”, the processing procedure proceeds to STEP S87.

In STEP S87 to S89, “issuance package Y” corresponding to “encryption key 8” and “encryption key 9” of the non-contact IC chip 13-1 is newly registered in the package information DB. After “issuance package Y” is linked to the setting item “package” in the encryption key package setting information DB, the package state of the non-contact IC chip 13-1 is set to “temporarily inaccessible”, and then the processing procedure is terminated.

According to the package update processing of FIG. 17, even when “encryption key 2” and “encryption key 3” of the non-contact IC chip 13-1 are changed to “encryption key 8” and “encryption key 9”, respectively, a new package can be generated at a timing designated by a user.

In the key storage DB 7, immediately after a generated package in the non-contact IC chip 13 is updated through the above package update processing procedure, the package state is in the state of “temporarily inaccessible”. The state change application 52 can change the package state of the non-contact IC chip 13 to “accessible”.

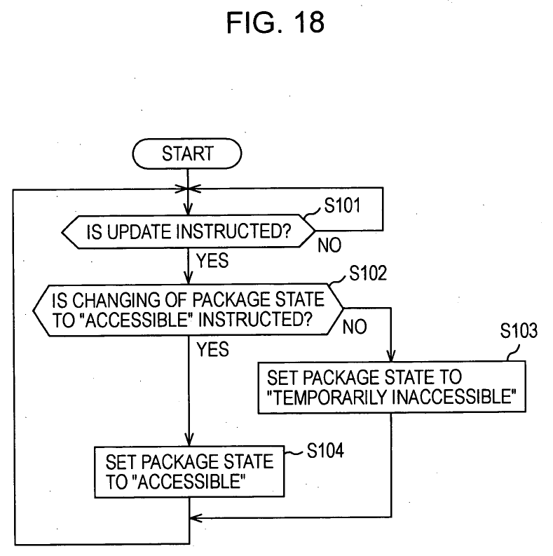

FIG. 18 illustrates a procedure of package state change processing performed by the state change application 52.

At STEP S101, the state change application 52 determines whether or not an instruction of changing the package state has been provided by a user operation, and waits until it is determined that the instruction has been provided.

If, in STEP S101, it is determined that the state change instruction has been provided, the state change application 52 determines whether or not the instruction is intended for changing of the package state of the non-contact IC chip 13 into “accessible” at STEP S102.

If, in STEP S102, the change instruction is determined to be not intended for changing of the package state in the non-contact IC chip 13 into “accessible”, the state change application 52 sets the package state in the non-contact IC chip 13 to “temporarily inaccessible” (i.e., the setting value of the setting item “state” of the non-contact IC chip 13 is set to “temporarily inaccessible”), at STEP S103.

On the other hand, if, in STEP S102, the change instruction is determined to be intended for changing of the package state in the non-contact IC chip 13 into “accessible”, the state change application 52 sets (changes) the package state in the non-contact IC chip 13 into “accessible” (i.e., the setting value of the setting item “state” of the non-contact IC chip 13 is set to “accessible”), at STEP S104.

After the processing of S103 or S104, the processing procedure returns to STEP S101 and is repeated until the state change application 52 is inactivated.

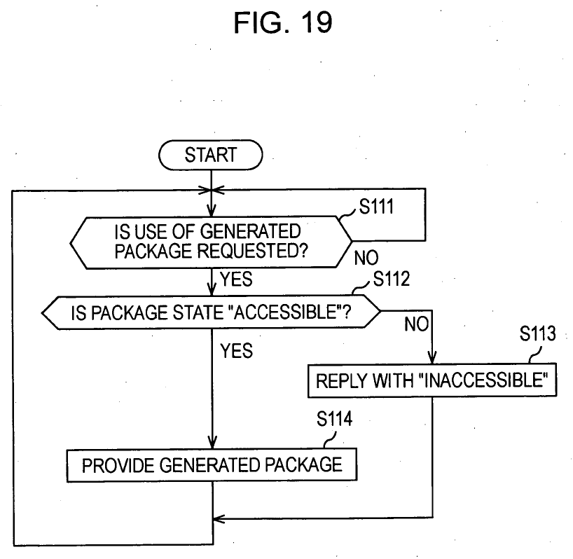

Now, referring to a flowchart of FIG. 19, a procedure of usage request response processing will be described which is performed by a request response unit 65 for responding to a request received from the server application 11 for use of a generated package.

At STEP S111, the request response unit 65 determines whether a request for use of the generated package in the non-contact IC chip 13 registered in the key storage DB 7 has been provided by the server application 11. The processing of S111 is repeated until it is determined the use request has been provided.

If, in STEP S111, it is determined that the generated package use request has been provided, the request response unit 65 determines whether or not the state of the requested package of the non-contact IC chip 13 is “accessible”, at STEP S112.

If, in STEP S112, the package state of the non-contact IC chip 13 is determined to be not “accessible”, the respond unit 65 replies with “inaccessible” for the generation package use request received from the server application 11, at STEP S113.

On the other hand, if, in STEP S112, the package state of the non-contact IC chip 13 is determined to be “accessible”, the request respond unit 65 replies with the requested generated package for the generation package use request received from the server application 11, at STEP S114.

After the processing of STEP S113 or STEP S114 is performed, the processing procedure returns to STEP S111 and is repeated until the DB management application 51 is inactivated.

As described above, in the non-contact IC chip 13 which is newly registered in the key storage DB 7 or in which a generated package (encryption key) is updated, the package state in the encryption key package setting information DB is set to “temporarily inaccessible” as the initial state. Then, through the package state change processing of FIG. 18, the package state can be set to “accessible” or “temporarily inaccessible”. This arrangement permits an operation such as checking a registration state or an operation state of the encryption key or the generated package of the non-contact IC chip 13, immediately after the non-contact IC chip 13 is newly registered or after the encryption key or the generated package is updated. In addition, the arrangement also permits temporary discontinuation of use of a service (use of an encryption key) which has been initiated.

Such a setting item as the package state of a generated package is not employed in related art. Therefore, it is likely that, for example, a service is unexpectedly used when the generated package is registered for test purpose before the service is actually provided to the holder of the non-contact IC chip 13. In addition, in related art, when use of a service is desired to be restricted (temporarily discontinued), all encryption keys and generated package of the non-contact IC chip 13 which are registered in the key storage DB 7 have to be deleted, resulting in complicated processing for the restriction of the service.

According to the DB management application 51, on the other hand, use of an encryption key or a generated package (use of a service) can be restricted even when the encryption key or the generated package remains registered in the key storage DB 7, as long as the package state of the non-contact IC chip 13 is “temporarily inaccessible”. This prevents the service from being unexpectedly used in a situation, for example, where the generated package is registered for test purpose before the service is actually provided to the holder of the non-contact IC chip 13. Moreover, to temporarily restrict the service, it is only necessary to change the package state of the non-contact IC chip 13 from “accessible” into “temporarily inaccessible”, which facilitates restricting the use of the service.

Thus, the server-client system of FIG. 3 can facilitate changing of an encryption key or a generated package to be provided to the non-contact IC chip 13.

In the foregoing examples, in the encryption key package setting information DB, the setting item “state” of the non-contact IC chip 13 indicates whether or not a generated package in the non-contact IC chip 13 can be used. However, the setting item can also indicate whether or not an encryption key in the non-contact IC chip 13 can be used. In this case, use of individual encryption keys can be restricted. Further, both of such states can be set so as to indicate whether or not the encryption key and the generated package can be used.

Moreover, either encryption keys registered in the encryption key information DB or a generated package registered in the package information DB can be a degenerate key generated by combining a plurality of encryption keys.

Furthermore, in the foregoing example, the encryption key package setting information DB, the encryption key information DB, and the package information DB are configured to be stored in the key storage DB 7 which is independent of the server apparatus 1. However, these databases can be stored in the storage section 108 of the server apparatus 1.

In the foregoing, the case is described where a non-contact IC chip is employed as an IC chip which can be controlled for implementing an embodiment of the present embodiment. However, a contact IC chip and an IC chip having functions of both a non-contact IC chip and a contact IC chip can be employed for implementing an embodiment of the present invention.

In this specification, processing steps described in the flowcharts include not only processing performed in time series in accordance with the order as described, but also processing which can be performed in parallel or independently.

In this specification, the term “system” represents the equipment constituted by a plurality of apparatuses.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus for performing processing of a storage device, wherein the storage device includes first storage means for storing encryption key setting information representing an encryption key used for sending and receiving encrypted information to and from an IC (Integrated Circuit) chip and package setting information representing a package having information concerning the encryption key, second storage means for storing the encryption key linked to the encryption key setting information in the first storage means, and third storage means for storing the package linked to the package setting information in the first storage means, the information processing apparatus comprising:
deleting means for, when the encryption key linked to the encryption key setting information in the first storage means has been deleted in the second storage means, deleting from the third storage means the package corresponding to the deleted encryption key linked to the package setting information in the first storage means; and
generating means for, when the package corresponding to the deleted encryption key has been deleted from the third storage means and a new encryption key has been stored in the second storage means instead of the deleted encryption key, generating a new package corresponding to the new encryption key linked to the encryption key setting information in the first storage means and storing the new package in the third storage means so as to be linked with the package setting information in the first storage means.

2. The information processing apparatus of claim 1, wherein the storage device is included in the information processing apparatus.

3. The information processing apparatus of claim 1,
wherein the first storage means further stores information indicating whether or not the encryption key can be used.

4. The information processing apparatus of claim 3, further comprising changing means for changing the information indicating whether or not the encryption key can be used.

5. The information processing apparatus of claim 3, further comprising responding means for responding to a request for use of the encryption key from a server for sending and receiving encrypted information to and from the IC chip, in accordance with the information indicating whether or not the encryption key can be used.

6. An information processing method for performing information processing for processing a storage device including first storage means for storing encryption key setting information representing an encryption key used for sending and receiving encrypted information to and from an IC (Integrated Circuit) chip and package setting information representing a package having information concerning the encryption key, second storage means for storing the encryption key linked to the encryption key setting information in the first storage means, and third storage means for storing the package linked to the package setting information in the first storage means, the information processing method comprising the steps of:
when the encryption key linked to the encryption key setting information in the first storage means has been deleted in the second storage means, deleting from the third storage means the package corresponding to the deleted encryption key linked to the package setting information in the first storage means; and
when the package corresponding to the deleted encryption key has been deleted from the third storage means and a new encryption key has been stored in the second storage means instead of the deleted encryption key, generating a new package corresponding to the new encryption key linked to the encryption key setting information in the first storage means and storing the new package in the third storage means so as to be linked with the package setting information in the first storage means.

7. A program for causing a computer to execute information processing for processing a storage device including first storage means for storing encryption key setting information representing an encryption key used for sending and receiving encrypted information to and from an IC (Integrated Circuit) chip and package setting information representing a package having information concerning the encryption key, second storage means for storing the encryption key linked to the encryption key setting information in the first storage means, and third storage means for storing the package linked to the package setting information in the first storage means, the program comprising the steps of:
when the encryption key linked to the encryption key setting information in the first storage means has been deleted in the second storage means, deleting from the third storage means the package corresponding to the deleted encryption key linked to the package setting information in the first storage means; and
when the package corresponding to the deleted encryption key has been deleted from the third storage means and a new encryption key has been stored in the second storage means instead of the deleted encryption key, generating a new package corresponding to the new encryption key linked to the encryption key setting information in the first storage means and storing the new package in the third storage means so as to be linked with the package setting information in the first storage means.

8. An information processing apparatus for performing processing of a storage device, wherein the storage device includes a first storage unit storing encryption key setting information representing an encryption key used for sending and receiving encrypted information to and from an IC (Integrated Circuit) chip and package setting information representing a package having information concerning the encryption key, a second storage unit storing the encryption key linked to the encryption key setting information in the first storage unit, and a third storage unit storing the package linked to the package setting information in the first storage unit, the information processing apparatus comprising;
a deleting unit, when the encryption key linked to the encryption key setting information in the first storage unit has been deleted in the second storage unit, deleting from the third storage unit the package corresponding to the deleted encryption key linked to the package setting information in the first storage unit; and
a generating unit, when the package corresponding to the deleted encryption key has been deleted from the third storage unit and a new encryption key has been stored in the second storage unit instead of the deleted encryption key, generating a new package corresponding to the new encryption key linked to the encryption key setting information in the first storage unit and storing the new package in the third storage unit so as to be linked with the package setting information in the first storage unit.
